(19) United States
(12) Patent Application Publication
(10) Pub. No.: US 2016/0072402 A1
(43) Pub. Date: Mar. 10, 2016

(54) RECTIFYING CIRCUIT AND CONTACTLESS IC CARD

(71) Applicant: Kabushiki Kaisha Toshiba, Tokyo (JP)

(72) Inventor: Tomoyuki Honma, Yokohama Kanagawa (JP)

(21) Appl. No.: 14/644,911

(22) Filed: Mar. 11, 2015

(30) Foreign Application Priority Data
Sep. 9, 2014 (JP) 2014-183555

(51) Int. Cl. H02M 7/217

(52) U.S. Cl. CPC H02M 7/217

(57) ABSTRACT

The rectifying circuit includes a first and a second transistor, a first and a second rectifying element, a first and a second switch element. A current path of the first transistor is connected between a reference potential and a first antenna terminal. A current path of the second transistor is connected between the reference potential and a second antenna terminal. The first rectifying element is connected between the first antenna terminal and a rectified current output node, a forward direction is from the first antenna terminal to the rectified current output node. The second rectifying element is connected between the second antenna terminal and the rectified current output node, a forward direction is from the second antenna terminal to the rectified current output node. The first switch element is connected in parallel with the first transistor. The second switch element is connected in parallel with the second transistor.

### CROSS-REFERENCE TO RELATED APPLICATION

This application is based upon and claims the benefit of priority from the prior Japanese Patent Application No. 2014-183555, filed on Sep. 9, 2014, the entire contents of which are incorporated herein by reference.

### FIELD

Embodiments described herein relate generally to a rectifying circuit and a contactless IC card.

### BACKGROUND

In an IC card communication system, a contactless IC card referred to also as a tag communicates with a reader/writer (referred to as an R/W, hereinafter). In the communication, the tag receives electric power from the R/W. The electric power the tag receives from the R/W is high when the distance between the tag and the R/W communicating with each other is short. In that case, the voltage at the antenna terminal of the tag needs to be higher than the chip withstanding voltage of the tag, so that the tag needs to limit the voltage at the antenna terminal. A method of limiting the voltage at the antenna terminal involves reducing the impedance at the antenna terminal or the rectified current output.

For example, a rectifying circuit that reduces the impedance uses a pn-junction diode. The pn-junction diode is turned on when the voltage at the cathode is equal to or lower than the ground potential, so that there is a possibility that a parasitic npn transistor is formed whose base is formed by the chip substrate, whose emitter is formed by the cathode of the diode, and whose collector is formed by an indefinite number of surrounding n-diffusion regions. To avoid malfunction of the tag due to the parasitic npn transistor, the pn-junction diode has to be isolated from the other n-diffusion regions, so that it is difficult to suppress the increase of the chip size.

Another conventional rectifying circuit uses an nMOS transistor. The nMOS transistor is kept in the on state almost throughout the period in which the voltage at the antenna terminal connected to the gate thereof is increasing, so that the impedance is substantially always low. Since the impedance is substantially always low, it is difficult for the R/W to detect a transmission signal sent from the tag by load modulation and to achieve predetermined communication characteristics.

### BRIEF DESCRIPTION OF THE DRAWINGS

FIG. 1 is a diagram showing an example of a configuration of a contactless IC card 1 according to a first embodiment;

FIG. 2 is a circuit diagram showing the rectifying circuit 11 according to the first embodiment;

FIG. 3 is a first schematic diagram showing an example of an operation of the rectifying circuit 11 shown in FIG. 2;

FIG. 4 is a second schematic diagram showing an example of an operation of the rectifying circuit 11 shown in FIG. 2;

FIGS. 5A and 5B are waveform diagrams of the voltage at an antenna terminal of the rectifying circuit 11 shown in FIG. 2;

FIG. 6 is a circuit diagram showing a rectifying circuit 11 according to a second embodiment;

FIG. 7 is a schematic diagram showing an example of an operation of the rectifying circuit 11 shown in FIG. 6; and

FIGS. 8A and 8B are waveform diagrams of the voltage at an antenna terminal of the rectifying circuit 11 shown in FIG. 2

### DETAILED DESCRIPTION

A rectifying circuit according to an embodiment includes a first transistor, a second transistor, a first rectifying element, a second rectifying element, a first switch element and a second switch element. The first transistor is connected to a reference potential at a first end of a current path thereof. The first transistor is connected to a first antenna terminal at a second end of the current path thereof. The second transistor is connected to the reference potential at a first end of a current path thereof. The second transistor is connected to a second antenna terminal at a second end of the current path thereof. The first rectifying element is connected between the first antenna terminal and a rectified current output node, a forward direction of which is a direction from the first antenna terminal to the rectified current output node. The second rectifying element is connected between the second antenna terminal and the rectified current output node, a forward direction of which is a direction from the second antenna terminal to the rectified current output node. The first switch element is connected in parallel with the first transistor between the reference potential and the first antenna terminal. The second switch element is connected in parallel with the second transistor between the reference potential and the second antenna terminal.

In the following, embodiments of the present invention will be described with reference to the drawings. The embodiments are not intended to limit the present invention.

### First Embodiment

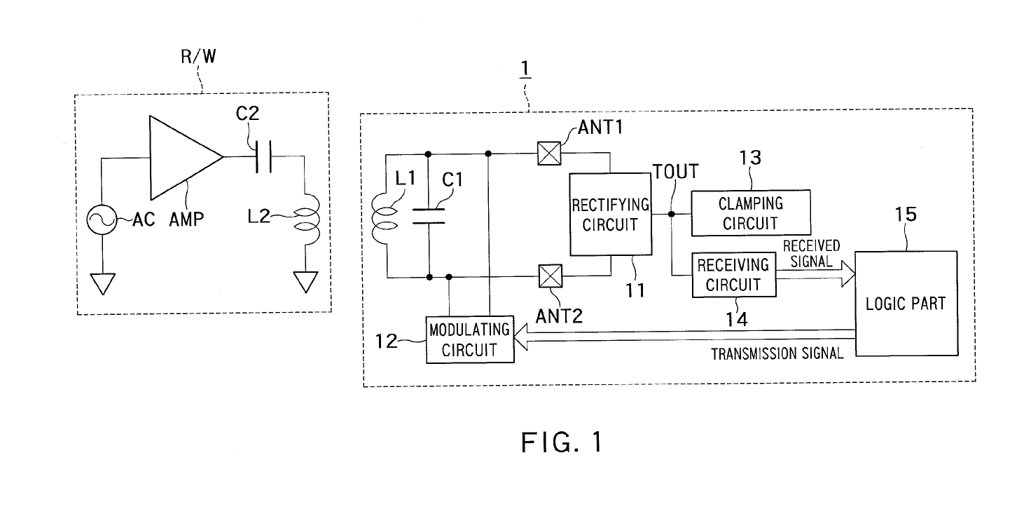

FIG. 1 is a diagram showing an example of a configuration of a contactless IC card 1 according to a first embodiment. The contactless IC card 1 shown in FIG. 1 can be used as a tag that communicates with an R/W by radio.

The contactless IC card may be a passive tag that operates on electric power derived from a rectified current from a rectifying circuit or an active tag that operates on electric power from a separate power supply, such as a battery. The contactless IC card 1 shown in FIG. 1 can be either of the active tag and the passive tag.

The contactless IC card 1 includes a rectifying circuit 11, a modulating circuit 12, a clamping circuit 13, a receiving circuit 14, a logic part 15, a first antenna coil “L1”, a first capacitor “C1”, a first antenna terminal “ANT1”, a second antenna terminal “ANT2”, and an output terminal “TOUT”.

The first antenna coil “L1” is connected to the first antenna terminal “ANT1” at one end thereof and to the second antenna terminal “ANT2” at another end thereof. The first antenna terminal “ANT1” is connected to a first input end of the rectifying circuit 11, and the second antenna terminal “ANT2” is connected to a second input end of the rectifying circuit 11.

The modulating circuit 12 is connected between the one end and the another end of the first antenna coil “L1”.

The clamping circuit 13 and the receiving circuit 14 are connected to the output terminal “TOUT”. The logic part 15, which is responsible for transmission and reception of a radio communication signal, is connected to an output end of the receiving circuit 14 and an input end of the modulating circuit 12.

On the other hand, the R/W includes a second antenna coil “L2”, a second capacitor “C2”, an amplifier “AMP”, and an alternating-current power supply “AC”, which are connected in series with each other. Although not shown, the R/W also includes a modulating circuit that performs amplitude shift keying (ASK) modulation on a carrier and a demodulating circuit that performs demodulation of a return signal from the contactless IC card 1.

When the contactless IC card 1 configured as described above receives a signal (referred to as a received signal hereinafter) from the R/W, the rectifying circuit 11 rectifies an induced current that occurs in the first antenna coil “L1” based on the radio communication with the R/W. More specifically, the rectifying circuit 11 rectifies an alternating current alternately input thereto at the first antenna terminal “ANT1” and the second antenna terminal “ANT2” into a direct current.

The rectifying circuit 11 can extract an ASK component of a magnetic field produced by the R/W, that is, the received signal from the R/W, by rectifying the current input at the first antenna terminal “ANT1” and the second antenna terminal “ANT2”. The rectifying circuit 11 outputs the extracted ASK component to the receiving circuit 14.

When the rectifying circuit 11 performs rectification, the clamping circuit 13 reduces the voltage at the rectified current output, that is, the voltage at the output terminal “TOUT”, thereby preventing the voltage that occurs at the first antenna terminal “ANT1” and the second antenna terminal “ANT2” from exceeding a withstand voltage of an element connected to the terminal “ANT1” or “ANT2”. For example, the clamping circuit 13 can reduce the voltage at the rectified current output by a resistance decreasing when the voltage at the rectified current output becomes equal to or higher than a threshold.

The receiving circuit 14 binarizes the ASK component extracted by the rectifying circuit 11 and outputs the resulting binary ASK component (received signal) to the logic part 15.

When the contactless IC card 1 transmits (sends back) a transmission signal to the R/W, the modulating circuit 12 sends the transmission signal input thereto from the logic part 15 back to the R/W by load modulation, that is, load switching. More specifically, the modulating circuit 12 changes impedances at the first antenna terminal “ANT1” and the second antenna terminal “ANT2”, thereby changing the voltage on the second antenna coil “L2” of the R/W.

Based on the change of the voltage on the second antenna coil “L2”, the R/W detects the transmission signal from the contactless IC card 1.

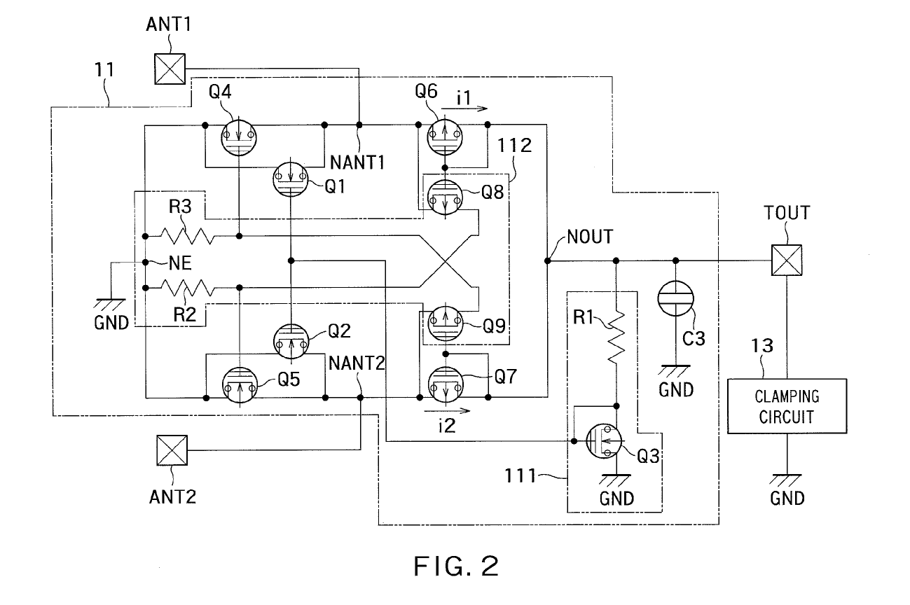

FIG. 2 is a circuit diagram showing the rectifying circuit 11 according to the first embodiment. As shown in FIG. 2, the rectifying circuit 11 includes a first MOS transistor “Q1”, a second MOS transistor “Q2”, a sixth MOS transistor “Q6”, which is an example of a first rectifying element, a seventh MOS transistor “Q7”, which is an example of a second rectifying element, a fourth MOS transistor “Q4”, which is an example of a first switch element, a fifth MOS transistor “Q5”, which is an example of a second switch element, a bias generating part 111, a voltage applying part 112, and a third capacitor “C3”.

The first MOS transistor “Q1” is an nMOS transistor that is connected to a gate of the second MOS transistor “Q2” at a gate (control end) thereof, to a ground potential “GND”, which is an example of a reference voltage, at a drain (one end of a current path) thereof, and to the first antenna terminal “ANT1” at a source (another end of the current path) thereof, for example. The second MOS transistor “Q2” is an nMOS transistor that is connected to the ground potential “GND” at a drain (one end) thereof and to the second antenna terminal “ANT2” at a source (another end) thereof.

The first MOS transistor “Q1” passes a second return current described later, which depends on a second current “i2” flowing from the second antenna terminal “ANT2” to the output terminal “TOUT”, from a ground node “NE” to the first antenna terminal “ANT1”. The second MOS transistor “Q2” passes a first return current described later, which depends on a first current “i41” flowing from the first antenna terminal “ANT1” to the output terminal “TOUT”, from the ground node “NE” to the second antenna terminal “ANT2”.

The sixth MOS transistor “Q6” is a pMOS transistor that is diode-connected between the first antenna terminal “ANT1” and the output terminal “TOUT”, a forward direction of which is the direction from the first antenna terminal “ANT1” to the output terminal “TOUT”, for example. The seventh MOS transistor “Q7” is a pMOS transistor that is diode-connected between the second antenna terminal “ANT2” and the output terminal “TOUT”, a forward direction of which is the direction from the second antenna terminal “ANT2” to the output terminal “TOUT”, for example.

The sixth MOS transistor “Q6” passes the first current “i1” in the forward direction. The seventh MOS transistor “Q7” passes the second current “i2” in the forward direction.

The fourth MOS transistor “Q4” is an nMOS transistor that is connected in parallel with the first MOS transistor “Q1” between the ground potential “GND” and the first antenna terminal “ANT1”, for example. The fourth MOS transistor “Q4” is connected to the voltage applying part 112 at a gate thereof, to the first antenna terminal “ANT1” at a source thereof and to the ground potential “GND” at a drain thereof.

The fourth MOS transistor “Q4” divides the second return current described later along with the first MOS transistor “Q1”. The impedance at the first antenna terminal “ANT1” can be reduced by dividing the second return current.

The fifth MOS transistor “Q5” is an nMOS transistor that is connected in parallel with the second MOS transistor “Q2” between the ground potential “GND” and the second antenna terminal “ANT2”, for example. The fifth MOS transistor “Q5” is connected to the voltage applying part 112 at a gate thereof, to the second antenna terminal “ANT2” at a source thereof and to the ground potential “GND” at a drain thereof.

The fifth MOS transistor “Q5” divides the first return current described later along with the second MOS transistor “Q2”. The impedance at the second antenna terminal “ANT2” can be reduced by dividing the first return current.

The bias generating part 111 is a constituent part that generates biases for the first MOS transistor “Q1” and the second MOS transistor “Q2”, and includes a first resistor “R1” and a third MOS transistor “Q3”.

The first resistor “R1” is connected to a rectified current output node “NOUT” at one end thereof. The third MOS transistor “Q3” is an nMOS transistor that is connected to a drain of the third MOS transistor “Q3”, the gate of the first MOS transistor “Q1” and the gate of the second MOS transistor “Q2” at a gate thereof, to the ground potential “GND” at a source thereof and to another end of the first resistor “R1” at the drain thereof, for example. The bias generating part 111 can turn on the first to third MOS transistors “Q1” to “Q3”.

The voltage applying part 112 is a constituent part that applies a voltage that depends on the second current “i2” flowing through the seventh MOS transistor “Q7” to the gate of the fourth MOS transistor “Q4” and applies a voltage that depends on the first current “i1” flowing through the sixth MOS transistor “Q6” to the gate of the fifth MOS transistor “Q5”.

The voltage applying part 112 includes an eighth MOS transistor “Q8”, a ninth MOS transistor “Q9”, a second resistor “R2”, and a third resistor “R3”.

The eighth MOS transistor “Q8” is a pMOS transistor that is connected to a gate of the sixth MOS transistor “Q6” at a gate thereof, to a source of the sixth MOS transistor “Q6” at a source thereof and to the gate of the fifth MOS transistor “Q5” and one end of the second resistor “R2” at a drain thereof, for example. The eighth MOS transistor “Q8” and the sixth MOS transistor “Q6” form a current mirror circuit. In other words, the eighth MOS transistor “Q8” mirrors the current “i1” flowing through the sixth MOS transistor “Q6”. The second resistor “R2” is connected to the ground potential “GND” at another end thereof.

The second resistor “R2” is connected between the gate and the source of the fifth MOS transistor “Q5”. A first mirror current “i1m” described later generated by the eighth MOS transistor “Q8” mirroring the first current “i1” flowing through the sixth MOS transistor “Q6” flows through the second resistor “R2”.

The eighth MOS transistor “Q8” and the second resistor “R2” can apply a voltage that depends on the first mirror current “i1m” described later to the gate of the fifth MOS transistor “Q5”.

The ninth MOS transistor “Q9” is a pMOS transistor that is connected to a gate of the seventh MOS transistor “Q7” at a gate thereof, to a source of the seventh MOS transistor “Q7” at a source thereof and to the gate of the fourth MOS transistor “Q4” and one end of the third resistor “R3” at a drain thereof, for example. The ninth MOS transistor “Q9” and the seventh MOS transistor “Q7” form a current mirror circuit. In other words, the ninth MOS transistor “Q9” mirrors the current “i2” flowing through the seventh MOS transistor “Q7”. The third resistor “R3” is connected to the ground potential “GND” at another end thereof.

The third resistor “R3” is connected between the gate and the source of the fourth MOS transistor “Q4”. A second mirror current “i2m” described later generated by the ninth MOS transistor “Q9” mirroring the second current “i2” flowing through the seventh MOS transistor “Q7” flows through the third resistor “R3”.

The ninth MOS transistor “Q9” and the third resistor “R3” can apply a voltage that depends on the second mirror current “i2m” described later to the gate of the fourth MOS transistor “Q4”.

The third capacitor “C3” is connected at one end thereof between the one end of the first resistor “R1” and the output terminal “TOUT” and to the ground potential “GND” at another end thereof.

The third capacitor “C3” can be charged and discharged to smooth a rectified current waveform or to optimize a turn-on operation of a circuit element of the rectifying circuit 11.

The size of the second MOS transistor “Q2” can be the same as the size of the first MOS transistor “Q1”. The size of the fifth MOS transistor “Q5” can be the same as the size of the fourth MOS transistor “Q4”. The size of the seventh MOS transistor “Q7” can be the same as the size of the sixth MOS transistor “Q6”. The size of the ninth MOS transistor “Q9” can be the same as the size of the eighth MOS transistor “Q8”. The configuration of the rectifying circuit 11 can be simplified by adopting such a symmetric transistor arrangement.

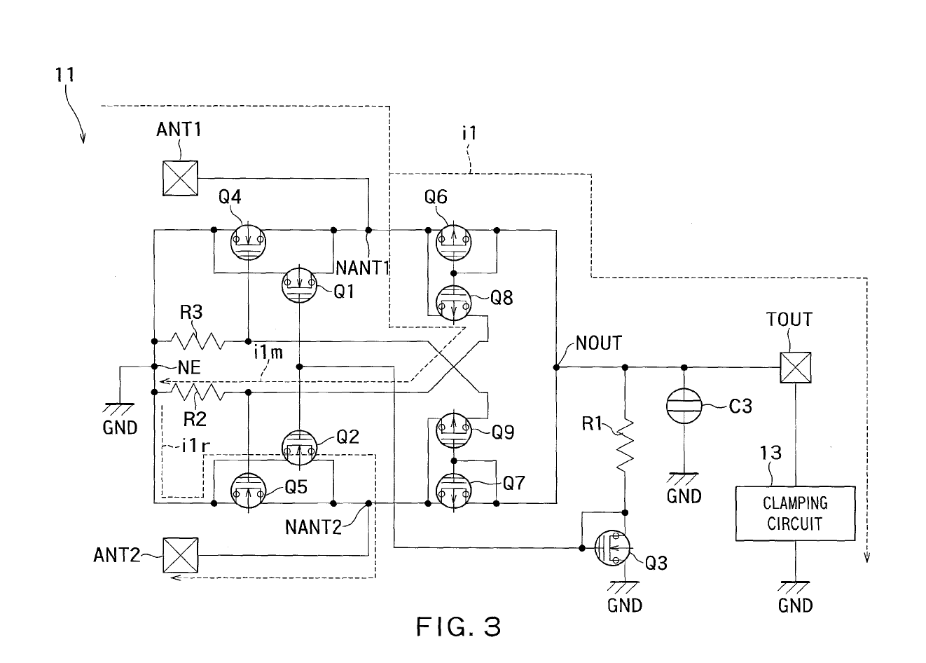

In the following, with reference to FIGS. 3 to 5, an example of an operation of the rectifying circuit 11 shown in FIG. 2 will be described. FIG. 3 is a first schematic diagram showing an example of an operation of the rectifying circuit 11 shown in FIG. 2. More specifically, FIG. 3 is a schematic diagram showing an example of an operation of the rectifying circuit 11 in a case where the voltage at the first antenna terminal “ANT1” is low, and the value of the first current “i1” flowing through the sixth MOS transistor “Q6” is lower than a first threshold. The first threshold is a threshold or, in other words, a lower limit value of the first current “i1” that turns on the fifth MOS transistor “Q5”.

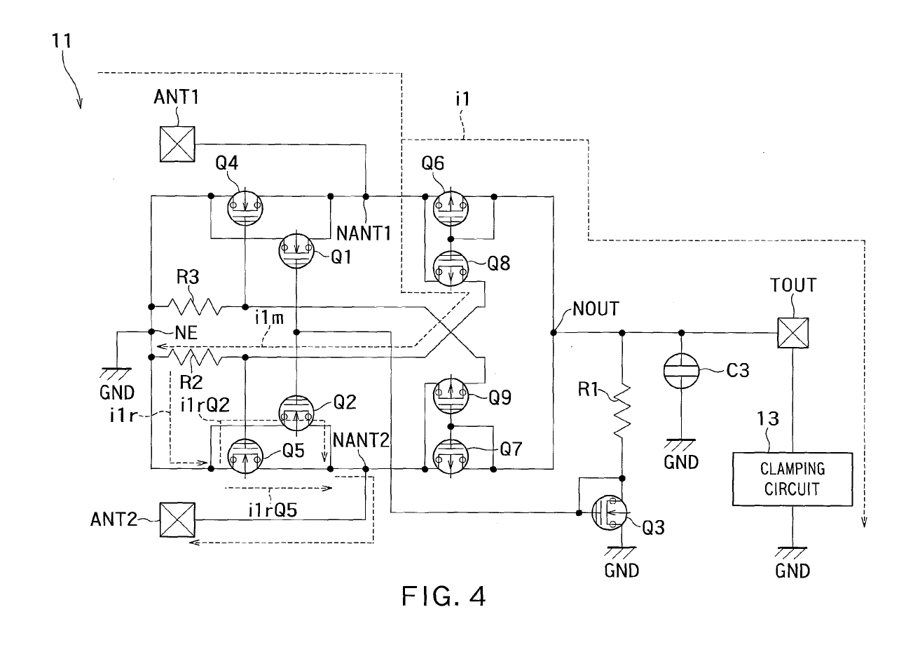

FIG. 4 is a second schematic diagram showing an example of an operation of the rectifying circuit 11 shown in FIG. 2. More specifically, FIG. 4 is a schematic diagram showing an example of an operation of the rectifying circuit 11 in a case where the voltage at the first antenna terminal “ANT1” is high, and the value of the first current “i1” is equal to or higher than the first threshold.

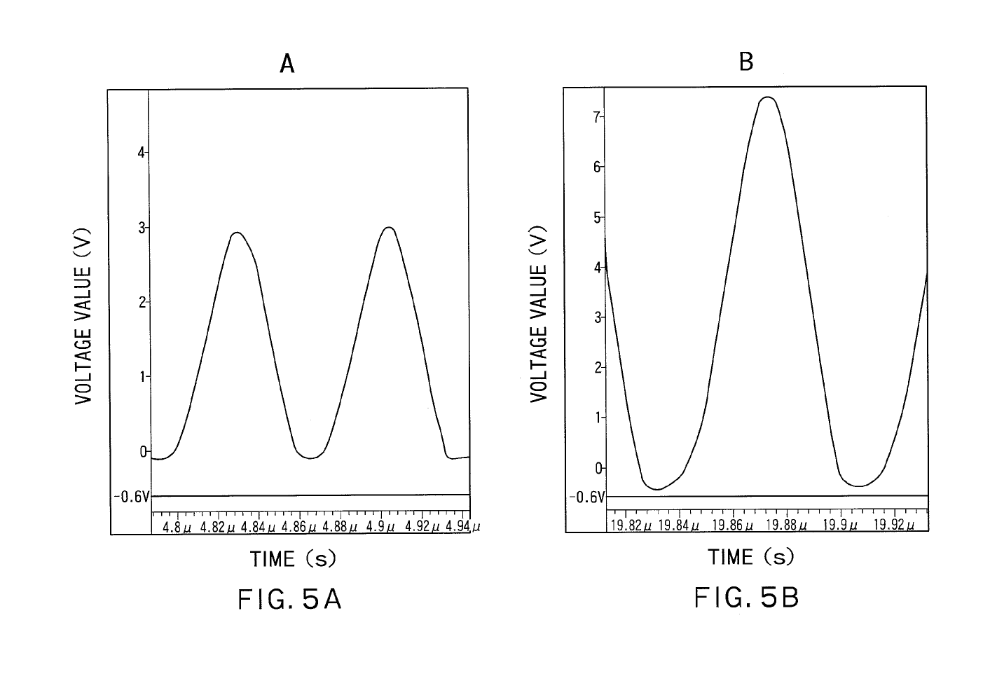

FIG. 5 includes waveform diagrams of the voltage at an antenna terminal of the rectifying circuit 11 shown in FIG. 2. In FIG. 5, the horizontal axis indicates time (s), and the vertical axis indicates voltage value (V). More specifically, FIG. 5A is a waveform diagram of the voltage at the second antenna terminal “ANT2” in the case where the voltage at the first antenna terminal “ANT1” is low (the case of the example shown in FIG. 3). FIG. 5B is a waveform diagram of the voltage at the second antenna terminal “ANT2” in the case where the voltage at the first antenna terminal “ANT1” is high (the case of the example shown in FIG. 4).

First, the example of the operation in the case shown in FIG. 3 where the voltage at the first antenna terminal “ANT1” is low will be described. Note that the first to ninth MOS transistors “Q1” to “Q9” are initially in the off state.

As shown in FIG. 3, the first current “i1” is input to the rectifying circuit 11 from the first antenna terminal “ANT1” via a first antenna connection node “NANT1”. The value of the first current “i1” is lower than the first threshold.

The rectifying circuit 11 then outputs the input first current “i1” to the output terminal “TOUT” via the sixth MOS transistor “Q6” and the rectified current output node “NOUT”.

In this process, the eighth MOS transistor “Q8” mirrors the first current “i1” flowing through the sixth MOS transistor “Q6” to generate the first mirror current “i1m” shown in FIG. 3. The value of the first mirror current “i1m” can be the same as the value of the first current “i1” or vary depending on the size ratio between the MOS transistors. The eighth MOS transistor “Q8” passes the generated first mirror current “i1m” to the second resistor “R2”.

A voltage occurs on the second resistor “R2” when the first mirror current “i1m” flows through the second resistor “R2”, and the voltage is applied to the gate of the fifth MOS transistor “Q5”. Since the value of the first current “i1” is lower than the first threshold, the voltage applied to the gate of the fifth MOS transistor “Q5” is lower than a threshold voltage “Vth”. Since the applied voltage is lower than the threshold voltage “Vth”, the fifth MOS transistor “Q5” remains in the off state.

A voltage occurs on the first resistor “R1” of the bias generating part 111 when part of the first current “i1” having flowed through the rectified current output node “NOUT” flows through the first resistor “R1”. The voltage is applied to the gates of the first MOS transistor “Q1”, the second MOS transistor “Q2” and the third MOS transistor “Q3”. Thus, the bias generating part 111 can control driving of the MOS transistors “Q1” to “Q3” at the same time.

If, depending on the resistance of the first resistor “R1” of the bias generating part 111, a voltage equal to or higher than the threshold voltage is applied to the gates of the first MOS transistor “Q1” and the second MOS transistor “Q2”, and the potential at the source becomes substantially equal to or lower than the ground potential “GND”, the first MOS transistor “Q1” and the second MOS transistor “Q2” are turned on, and the impedance thereof decreases.

If, depending on the resistance of the first resistor “R1”, a voltage equal to or higher than the threshold voltage is applied to the gate of the third MOS transistor “Q3”, the third MOS transistor “Q3” is turned on to connect the gate of the first MOS transistor “Q1” and the gate of the second MOS transistor “Q2” to the ground potential “GND”.

Therefore, if the first current “i1” is lower than the first threshold, the fifth MOS transistor “Q5” remains in the off state, while the second MOS transistor “Q2” is turned on.

A current output at the output terminal “TOUT”, that is, a rectified current is input to the clamping circuit 13. The clamping circuit 13 returns the input current as a first return current “i1r” (see FIG. 3) to the rectifying circuit 11 via the ground potential “GND” and the ground node “NE”.

The first return current “i1r” flows to the second antenna terminal “ANT2” through the second MOS transistor “Q2” in the on state. Since the fifth MOS transistor “Q5” is in the off state, however, the first return current “i1r” does not flow through the fifth MOS transistor “Q5”.

At this point, the voltage at the first antenna terminal “ANT1” has been increased to such an extent as to make the third MOS transistor “Q3” operate in a pentode region, so that the lower limit voltage at the second antenna terminal “ANT2” is substantially at the level of the ground potential “GND” (see FIG. 5A).

That is, the lower limit voltage at the second antenna terminal “ANT2” does not decrease to a voltage (equal to or lower than −0.6 V in FIG. 5) with which a parasitic npn transistor is formed between the second MOS transistor “Q2” and an n-diffusion region connected to the second antenna terminal “ANT2”.

Thus, if the first current “i1” is lower than the first threshold, a parasitic npn transistor can be prevented from being formed between the second MOS transistor “Q2” and the n-diffusion region on the side of the second antenna terminal “ANT2”, even if the fifth MOS transistor “Q5” is in the off state.

If the fifth MOS transistor “Q5” is turned on when the first current “i1” is lower than the first threshold, the impedance at the second antenna terminal “ANT2” becomes unnecessarily low even under the condition that formation of a parasitic npn transistor is prevented as described above. In that case, the impedance at the second antenna terminal “ANT2” may be always kept low, so that the R/W cannot appropriately detect the transmission signal sent by load modulation by the rectifying circuit 11.

According to this embodiment, however, when the first current “i1” is lower than the first threshold, the fifth MOS transistor “Q5” can be kept in the off state, thereby preventing the impedance at the second antenna terminal “ANT2” from being always kept low.

Note that the voltage at the first antenna terminal “ANT1” may be too low to turn on the third MOS transistor “Q3”. In such a case, the third MOS transistor “Q3” cannot control the lower limit voltage at the second antenna terminal “ANT2” to be at the level of the ground potential “GND”, and therefore, a parasitic npn transistor may be formed between the second MOS transistor “Q2” and the n-diffusion region on the side of the second antenna terminal “ANT2”.

In such a case, however, even if a parasitic npn transistor is formed, the current flowing through the parasitic npn transistor is small enough not to have an adverse effect on the operational characteristics of the circuit, because the voltage at the first antenna terminal “ANT1” is low, and therefore the return current flowing through the second MOS transistor “Q2” is also small.

Next, an example of the operation in the case shown in FIG. 4 where the voltage at the first antenna terminal “ANT1” is high will be described. As in the case shown in FIG. 3, it is assumed that the MOS transistors “Q1” to “Q9” are initially in the off state.

In the case shown in FIG. 4, the first current “i1” having a value equal to or higher than the first threshold is input to the rectifying circuit 11 from the first antenna terminal “ANT1”.

Since the value of the first current “i1” is equal to or higher than the first threshold, the eighth MOS transistor “Q8” and the second resistor “R2” apply a voltage equal to or higher than the threshold voltage “Vth” to the gate of the fifth MOS transistor “Q5”. Since the voltage equal to or higher than the threshold voltage “Vth” is applied, the fifth MOS transistor “Q5” is turned on. As in the case shown in FIG. 3, the second MOS transistor “Q2” and the third MOS transistor “Q3” are turned on depending on the voltage applied to the gate thereof from the first resistor “R1”.

Therefore, if the value of the first current “i1” is equal to or higher than the first threshold, both the second MOS transistor “Q2” and the fifth MOS transistor “Q5” are turned on.

When the fifth MOS transistor “Q5” is turned on, the fifth MOS transistor “Q5” passes part “i1rQ5” of the first return current “i1r” therethrough. The second MOS transistor “Q2” passes the remainder “i1rQ2” of the first return current “i1r” therethrough.

If the voltage at the first antenna terminal “ANT1” is high, the first return current “i1r” is large. Under this condition, if the first return current “ilr” flows only through the second MOS transistor “Q2”, the decrease of the voltage at the second antenna terminal “ANT2” is increases. As a result, a parasitic npn transistor is formed between the second MOS transistor “Q2” and the n-diffusion region on the side of the second antenna terminal “ANT2”.

According to this embodiment, however, when the voltage at the first antenna terminal “ANT1” is high, the first return current can be divided between the second MOS transistor “Q2” and the fifth MOS transistor “Q5”, so that the decrease of the voltage at the second antenna terminal “ANT2” can be reduced. Since the decrease of the voltage at the second antenna terminal “ANT2” can be reduced, the impedance at the second antenna terminal “ANT2” can be reduced. Since the impedance at the second antenna terminal “ANT2” can be reduced, a parasitic npn transistor can be prevented from being formed between the second MOS transistor “Q2” and the n-diffusion region on the side of the second antenna terminal “ANT2”.

For example, as shown in FIG. 5B, the lower limit voltage at the second antenna terminal “ANT2” is higher than −0.6V, because the fifth MOS transistor “Q5” is turned on. The waveform diagram of FIG. 5B shows that no parasitic npn transistor is formed.

An example of the operation in the case where the first current “i1” flows from the first antenna terminal “ANT1” to the rectifying circuit 11 has been described above. An example of the operation in the case where the second current “i2” flows from the second antenna terminal “ANT2” to the rectifying circuit 11 can be described in the same way.

Specifically, first, if the voltage at the second antenna terminal “ANT2” is low, a second current “i2” lower than a second threshold is input to the rectifying circuit 11 from the second antenna terminal “ANT2” via a second antenna connection node “NANT2”. The second threshold is a threshold or, in other words, a lower limit value of the second current “i2” that turns on the fourth MOS transistor “Q4”. The rectifying circuit 11 outputs the input second current “i2” to the output terminal “TOUT” via the seventh MOS transistor “Q7” and the rectified current output node “NOUT”.

The ninth MOS transistor “Q9” mirrors the second current “i2” flowing through the seventh MOS transistor “Q7” to generate a second mirror current (not shown). The value of the second mirror current can be the same as the value of the second current “i2” or vary depending on the size ratio between the MOS transistors. The ninth MOS transistor “Q9” passes the generated second mirror current to the third resistor “R3”.

A voltage occurs on the third resistor “R3” when the second mirror current flows through the third resistor “R3”, and the voltage is applied to the gate of the fourth MOS transistor “Q4”. Since the value of the second current “i2” is lower than the second threshold, the voltage applied to the gate of the fourth MOS transistor “Q4” is lower than the threshold voltage “Vth”. Since the applied voltage is lower than the threshold voltage “Vth”, the fourth MOS transistor “Q4” remains in the off state. The first MOS transistor “Q1” and the third MOS transistor “Q3” are turned on in the same way as in the case shown in FIG. 3.

Therefore, if the second current “i2” is lower than the second threshold, the fourth MOS transistor “Q4” remains in the off state, while the first MOS transistor “Q1” is turned on.

A rectified current output at the output terminal “TOUT” is input to the clamping circuit 13. The clamping circuit 13 returns the input current as a second return current (not shown) to the rectifying circuit 11 via the ground potential “GND” and the ground node “NE”.

The second return current flows to the first antenna terminal “ANT1” through the first MOS transistor “Q1” in the on state. Since the fourth MOS transistor “Q4” is in the off state, however, the second return current does not flow through the fourth MOS transistor “Q4”.

At this point, the voltage at the second antenna terminal “ANT2” has been increased to such an extent as to make the third MOS transistor “Q3” operate in the pentode region, so that the lower limit voltage at the first antenna terminal “ANT1” is substantially at the level of the ground potential “GND”.

That is, the lower limit voltage at the first antenna terminal “ANT1” does not decrease to a voltage with which a parasitic npn transistor is formed between the first MOS transistor “Q1” and an n-diffusion region connected to the first antenna terminal “ANT1”.

Thus, if the second current “i2” is lower than the second threshold, a parasitic npn transistor can be prevented from being formed between the first MOS transistor “Q1” and the n-diffusion region on the side of the first antenna terminal “ANT1”, even if the fourth MOS transistor “Q4” is in the off state.

In addition, according to this embodiment, when the second current “i2” is lower than the second threshold, the fourth MOS transistor “Q4” can be kept in the off state, thereby preventing the impedance at the first antenna terminal “ANT1” from being always kept low.

If the voltage at the second antenna terminal “ANT2” is high, a second current “i2” having a value equal to or higher than the second threshold is input to the rectifying circuit 11 from the second antenna terminal “ANT2”.

Since the value of the second current “i2” is equal to or higher than the second threshold, the ninth MOS transistor “Q9” and the third resistor “R3” apply a voltage equal to or higher than the threshold voltage “Vth” to the gate of the fourth MOS transistor “Q4”. Since the voltage equal to or higher than the threshold voltage “Vth” is applied, the fourth MOS transistor “Q4” is turned on. The first MOS transistor “Q1” is turned on in the same way as in the case where the voltage at the second antenna terminal “ANT2” is low.

Therefore, if the value of the second current “i2” is equal to or higher than the second threshold, both the first MOS transistor “Q1” and the fourth MOS transistor “Q4” are turned on.

When the fourth MOS transistor “Q4” is turned on, the fourth MOS transistor “Q4” passes part of the second return current therethrough. The first MOS transistor “Q1” passes the remainder of the second return current therethrough.

According to this embodiment, when the voltage at the second antenna terminal “ANT2” is high, the second return current can be divided between the first MOS transistor “Q1” and the fourth MOS transistor “Q4”, so that the decrease of the voltage at the first antenna terminal “ANT1” can be reduced. Since the decrease of the voltage at the first antenna terminal “ANT1” can be reduced, the impedance at the first antenna terminal “ANT1” can be reduced. Since the impedance at the first antenna terminal “ANT1” can be reduced, a parasitic npn transistor can be prevented from being formed between the first MOS transistor “Q1” and the n-diffusion region on the side of the first antenna terminal “ANT1”.

As described above, the rectifying circuit 11 according to this embodiment can turn on the fourth MOS transistor “Q4” and the fifth MOS transistor “Q5” and reduce the impedance when the voltage at the antenna terminal “ANT1” or “ANT2” is high, and prevention of formation of a parasitic npn transistor is needed. Since the impedance can be reduced, isolation between the rectifying element and the n-diffusion region on the side of the antenna terminal “ANT1” or “ANT2” intended for prevention of formation of a parasitic npn transistor is not needed.

In addition, since the rectifying circuit 11 according to this embodiment can reduce the impedance as required, the R/W can more easily detect the transmission signal sent by load modulation, compared with the case where the impedance is always kept low. This means that the rectifying circuit 11 according to this embodiment can have predetermined communication characteristics while suppressing the increase of the chip size.

### Second Embodiment

In the following, a second embodiment will be described. In the description of this embodiment, the components corresponding to those in the first embodiment will be denoted by the same reference numerals, and redundant descriptions thereof will be omitted.

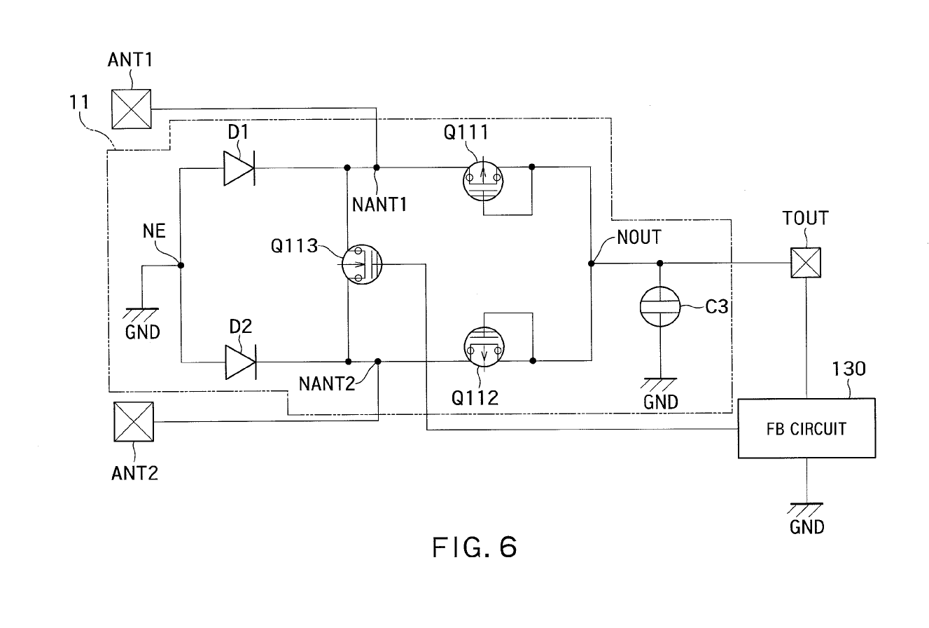

FIG. 6 is a circuit diagram showing a rectifying circuit 11 according to the second embodiment. As shown in FIG. 6, the rectifying circuit 11 includes a first diode “D1”, which is an example of the first rectifying element, a second diode “D2”, which is an example of the second rectifying element, an eleventh MOS transistor “Q111”, which is an example of a third rectifying element, a twelfth MOS transistor “Q112”, which is an example of a fourth rectifying element, and a thirteenth MOS transistor “Q113”, which is an example of a resistive circuit.

As shown in FIG. 6, a contactless IC card 1 includes a feedback (FB) circuit 130.

The first diode “D1” is a pn-junction diode that is connected to a ground potential “GND”, which is an example of the reference potential, at an anode thereof and to a first antenna terminal “ANT1” at a cathode thereof. The second diode “D2” is a pn-junction diode that is connected to the ground potential “GND” at an anode thereof and to a second antenna terminal “ANT2” at a cathode thereof.

The first diode “D1” can pass a return current that depends on a current flowing from the second antenna terminal “ANT2” to an output terminal “TOUT” from a ground node “NE” to the first antenna terminal “ANT1”. The second diode “D2” can pass a return current that depends on a current flowing from the first antenna terminal “ANT1” to the output terminal “TOUT” from the ground node “NE” to the second antenna terminal “ANT2”.

The eleventh MOS transistor “Q111” is a pMOS transistor that is diode-connected between the first antenna terminal “ANT1” and the output terminal “TOUT”, a forward direction of which is the direction from the first antenna terminal “ANT1” to the output terminal “TOUT”. The twelfth MOS transistor “Q112” is a pMOS transistor that is diode-connected between the second antenna terminal “ANT2” and the output terminal “TOUT”, a forward direction of which is the direction from the second antenna terminal “ANT2” to the output terminal “TOUT”.

The eleventh MOS transistor “Q111” can pass the current input to the rectifying circuit 11 from the first antenna terminal “ANT1” in the forward direction. The twelfth MOS transistor “Q112” can pass the current input to the rectifying circuit 11 from the second antenna terminal “ANT2” in the forward direction.

The thirteenth MOS transistor “Q113” is an nMOS transistor that is connected to the feedback circuit 130 at a gate thereof, to the second antenna terminal “ANT2” at a source thereof and to the first antenna terminal “ANT1” at a drain thereof.

The thirteenth MOS transistor “Q113” can pass an inter-antenna-terminal current “iANT” described later.

The feedback circuit 130 is a circuit that applies a voltage that depends on the voltage at the output terminal “TOUT” to the gate of the thirteenth MOS transistor “Q113”. More specifically, the feedback circuit 130 applies a high voltage to the gate of the thirteenth MOS transistor “Q113” when the voltage at the output terminal “TOUT” is high, and applies a low voltage to the gate of the thirteenth MOS transistor “Q113” when the voltage at the output terminal “TOUT” is low.

For example, the feedback circuit 130 may apply a voltage equal to or higher than a threshold voltage “Vth” to the gate of the thirteenth MOS transistor “Q113” when the voltage at the output terminal “TOUT” is equal to or higher than a threshold. Alternatively, the feedback circuit 130 may apply to the gate of the thirteenth MOS transistor 133 a band gap reference voltage that is based on the difference between the voltage at the output terminal “TOUT” and the ground potential “GND”.

The feedback circuit 130 can turn on the thirteenth MOS transistor “Q113”.

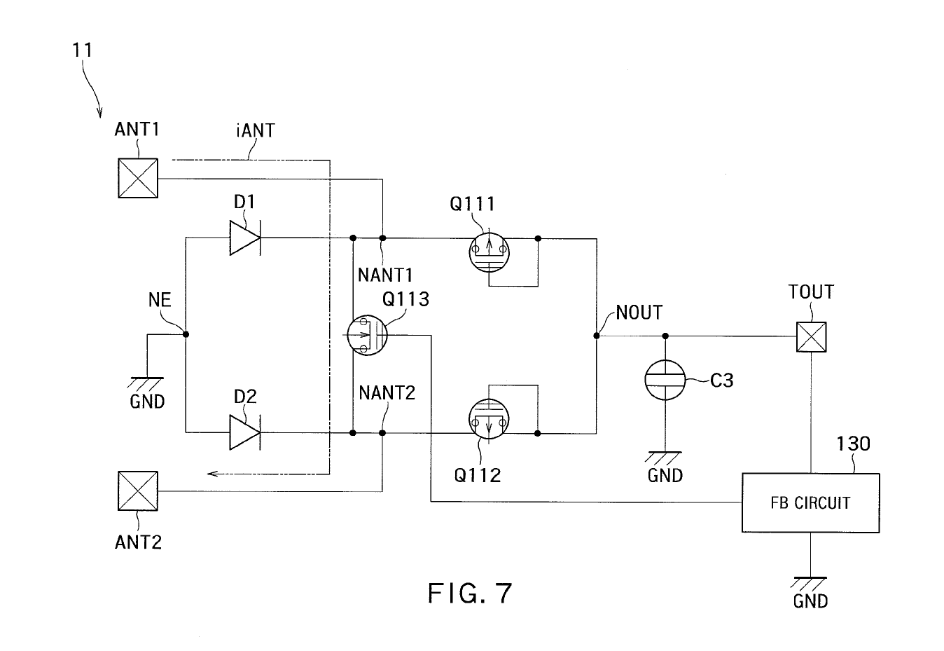

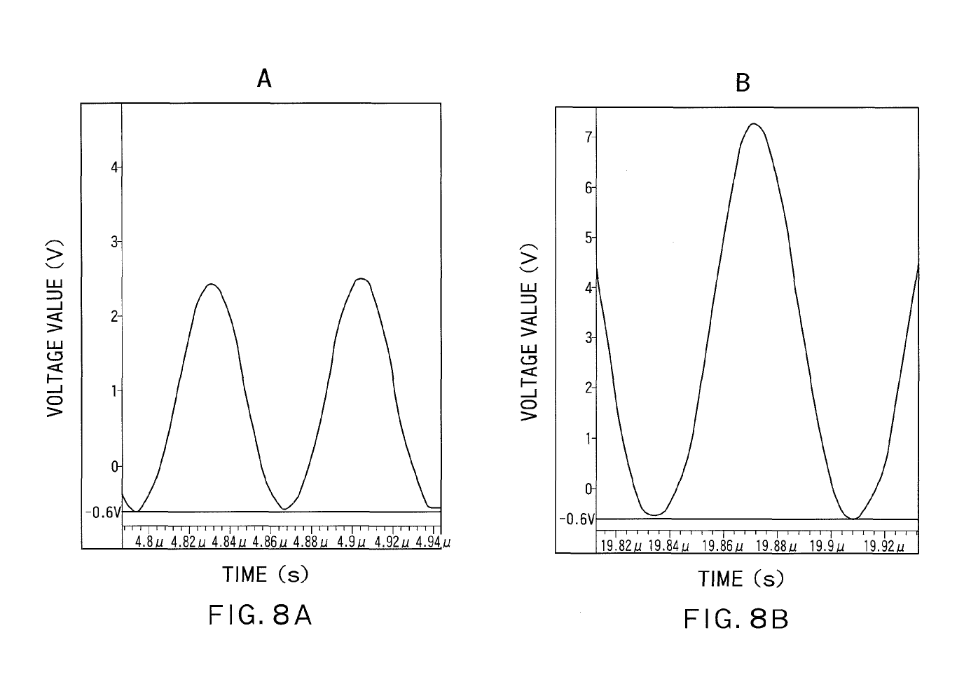

FIG. 7 is a schematic diagram showing an example of an operation of the rectifying circuit 11 shown in FIG. 6. FIG. 8 includes waveform diagrams of the voltage at an antenna terminal of the rectifying circuit 11 shown in FIG. 6. Specifically, FIG. 8 shows waveforms of the voltage at the second antenna terminal “ANT2”.

The rectifying circuit 11 outputs a current input thereto from the first antenna terminal “ANT1” via a first antenna connection node “NANT1” to the output terminal “TOUT” via the eleventh MOS transistor “Q111” and a rectified current output node “NOUT”. The current output to the output terminal “TOUT” is input to the feedback circuit 130. The feedback circuit 130 returns the current via the ground potential “GND” and the ground node “NE”. The second diode “D2” passes the returned current to the side of the second antenna terminal “ANT2”.

Based on the current input thereto from the output terminal “TOUT”, the feedback circuit 130 calculates the voltage at the output terminal “TOUT”. If the voltage at the output terminal “TOUT” is equal to or higher than a threshold, the feedback circuit 130 increases the gate voltage of the thirteenth MOS transistor “Q113” to be equal to or higher than the threshold voltage “Vth”.

Therefore, when the voltage at the output terminal “TOUT” is low, the on-resistance of the thirteenth MOS transistor “Q113” increases, and the thirteenth MOS transistor “Q113” is kept in the off state. When the voltage at the output terminal “TOUT” is high, the on-resistance of the thirteenth MOS transistor “Q113” decreases, and the thirteenth MOS transistor “Q113” is turned on.

When the thirteenth MOS transistor “Q113” is turned on, the inter-antenna-terminal current “iANT” flows between the first antenna terminal “ANT1” and the second antenna terminal “ANT2” as shown in FIG. 7. The inter-antenna-terminal current “iANT” can reduce the impedance at the second antenna terminal “ANT2”.

In both the cases where the voltage at the first antenna terminal “ANT1” is low (FIG. 8A) and where the voltage at the first antenna terminal “ANT1” is high (FIG. 8B), the voltage at the second antenna terminal “ANT2” decreases to a voltage (−0.6V) with which a parasitic npn transistor is formed between the second diode “D2” and an n-diffusion region on the side of the second antenna terminal “ANT2”.

However, when the voltage at the first antenna terminal “ANT1” is low, the input current at the terminal “ANT1” is small. Therefore, even if the thirteenth MOS transistor “Q113” is in the off state, the current flowing to the second diode “D2” is small, and the forward voltage of the second diode “D2” is low. Therefore, the voltage between a base and an emitter of the parasitic npn transistor is also low, and the current flowing through the parasitic npn transistor is small.

When the voltage at the first antenna terminal “ANT1” is high, the thirteenth MOS transistor “Q113” shunts a part of the input current at the terminal “ANT1” to provide the inter-antenna-terminal current “iANT”, so that a reduced amount of current flows to the second diode “D2”. Therefore, as in the case where the voltage at the first antenna terminal “ANT1” is low, the current flowing through the parasitic npn transistor is small.

If the frequency characteristics of the feedback circuit 130 is set to be frequency characteristics that is low enough for the feedback circuit 130 not to follow the period of the voltage at the antenna terminal “ANT1” or “ANT2”, the on-resistance of the thirteenth MOS transistor “Q113” is substantially kept constant during the period of the voltage at the antenna terminal “ANT1” or “ANT2”. However, even if the on-resistance of the thirteenth MOS transistor “Q113” is substantially constant, the inter-antenna-terminal current “iANT” is large when the potential difference between the antenna terminals “ANT1” and “ANT2” is large, and does not flow when the antenna terminals “ANT1” and “ANT2” are at the same potential. Therefore, the impedances at the antenna terminals “ANT1” and “ANT2” do not unnecessarily decrease.

The rectifying circuit 11 according to this embodiment can prevent a large current from flowing to the anodes of the first and second diodes “D1” and “D2” via the ground potential “GND” by the thirteenth MOS transistor “Q113” adjusting the resistance between the first and second antenna terminals “ANT1” and “ANT2”. Since a large current can be prevented from flowing to the anodes of the first and second diodes “D1” and “D2”, the current flowing to the parasitic npn transistor between the first and second diodes “D1” and “D2” and the n-diffusion region on the side of the antenna terminals “ANT1” and “ANT2” can be reduced to a level at which the current does not pose any practical problem.

In addition, the rectifying circuit 11 according to this embodiment can prevent an unnecessary decrease of the impedances at the first and second antenna terminals “ANT1” and “ANT2”. That is, the rectifying circuit 11 according to this embodiment has the same advantages as the rectifying circuit 11 according to the first embodiment. In addition, the rectifying circuit 11 according to this embodiment is composed of a smaller number of components than the rectifying circuit 11 according to the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A rectifying circuit, comprising:
a first transistor connected to a reference potential at a first end of a current path thereof and to a first antenna terminal at a second end of the current path thereof;
a second transistor connected to the reference potential at a first end of a current path thereof and to a second antenna terminal at a second end of the current path thereof;
a first rectifying element connected between the first antenna terminal and a rectified current output node, a forward direction of which is a direction from the first antenna terminal to the rectified current output node;
a second rectifying element connected between the second antenna terminal and the rectified current output node, a forward direction of which is a direction from the second antenna terminal to the rectified current output node;
a first switch element connected in parallel with the first transistor between the reference potential and the first antenna terminal; and
a second switch element connected in parallel with the second transistor between the reference potential and the second antenna terminal.

2. The rectifying circuit according to claim 1, wherein the first switch element is controlled depending on a second current flowing through the second rectifying element, and
the second switch element is controlled depending on a first current flowing through the first rectifying element.

3. The rectifying circuit according to claim 2, wherein the first switch element is turned off and the first transistor is turned on when the second current is lower than a second threshold,
both the first switch element and the first transistor are turned on when the second current is equal to or higher than the second threshold,
the second switch element is turned off and the second transistor is turned on when the first current is lower than a first threshold, and
both the second switch element and the second transistor are turned on when the first current is equal to or higher than the first threshold.

4. The rectifying circuit according to claim 3, wherein
the rectifying circuit further comprises:
a voltage generating part that generates, from a current flowing to the rectified current output node, a voltage to be supplied to the control ends of the first transistor and the second transistor.

5. The rectifying circuit according to claim 4, wherein the voltage generating part comprises:
a first resistor connected to the rectified current output node at a first end thereof; and
a third transistor connected to a second end of the first resistor at a first end of a current path thereof, to the reference potential at a second end of the current path thereof, and to the first end of the current path thereof and the control ends of the first transistor and the second transistor at a control end thereof.

6. The rectifying circuit according to claim 3, wherein the first switch element is a fourth transistor that is connected to the reference potential at a first end of a current path thereof and to the first antenna terminal at a second end of the current path thereof,
the second switch element is a fifth transistor that is connected to the reference potential at a first end of a current path thereof and to the second antenna terminal at a second end of the current path thereof, and
the rectifying circuit further comprises:
a voltage applying part that applies a voltage that depends on the second current to a control end of the fourth transistor and applies a voltage that depends on the first current to a control end of the fifth transistor.

7. The rectifying circuit according to claim 6, wherein the first rectifying element is a sixth transistor connected to the first antenna terminal at a first end of a current path thereof and to the rectified current output node at a second end of the current path and a control end thereof,
the second rectifying element is a seventh transistor connected to the second antenna terminal at a first end of a current path thereof and to the rectified current output node at a second end of the current path and a control end thereof,
the voltage applying part comprises:
an eighth transistor connected to the first antenna terminal at a first end of a current path thereof and to the control end of the fifth transistor at a second end of the current path thereof and to the control end of the sixth transistor at a control end thereof,
a ninth transistor connected to the second antenna terminal at a first end of a current path thereof and to the control end of the fourth transistor at a second end of the current path thereof and to the control end of the seventh transistor at a control end thereof,
a second resistor connected to the control end of the fifth transistor at a first end thereof and to the reference potential at a second end thereof, and
a third resistor connected to the control end of the fourth transistor at a first end thereof and to the reference potential at a second end thereof.

8. The rectifying circuit according to claim 3, wherein the reference potential is a ground potential,
the first transistor is an nMOS transistor connected to the ground potential at a drain thereof and to the first antenna terminal at a source thereof, and
the second transistor is an nMOS transistor connected to the ground potential at a drain thereof and to the second antenna terminal at a source thereof.

9. The rectifying circuit according to claim 1, wherein the first switch element is a fourth transistor connected to the reference potential at a first end of a current path thereof and to the first antenna terminal at a second end of the current path thereof,
the second switch element is a fifth transistor connected to the reference potential at a first end of a current path thereof and to the second antenna terminal at a second end of the current path thereof,
the first rectifying element is a sixth transistor that is diode-connected between the first antenna terminal and an output terminal, a forward direction of which is a direction from the first antenna terminal to the output terminal, the second rectifying element is a seventh transistor that is diode-connected between the second antenna terminal and the output terminal, a forward direction of which is a direction from the second antenna terminal to the output terminal, and the rectifying circuit comprises:
a second resistor that is connected between a control end and a first end of a current path of the fifth transistor and through which a mirror current of a first current flowing through the sixth transistor flows; and
a third resistor that is connected between a control end and a second end of the current path of the fourth transistor and through which a mirror current of a second current flowing through the seventh transistor flows.

10. A rectifying circuit, comprising:
a first rectifying element connected between a reference potential and a first antenna terminal, a forward direction of which is a direction from the reference potential to the first antenna terminal;
a second rectifying element connected between the reference potential and a second antenna terminal, a forward direction of which is a direction from the reference potential to the second antenna terminal;
a third rectifying element connected between the first antenna terminal and an output terminal, a forward direction of which is a direction from the first antenna terminal to the output terminal;
a fourth rectifying element connected between the second antenna terminal and the output terminal, a forward direction of which is a direction from the second antenna terminal to the output terminal; and
a resistive circuit connected between the first antenna terminal and the second antenna terminal.

11. The rectifying circuit according to claim 10, wherein the resistive circuit has
a low resistance when a voltage at the output terminal is high, and
a high resistance when the voltage at the output terminal is low.

12. The rectifying circuit according to claim 10, wherein the resistive circuit has
a low on-resistance when a voltage at the output terminal is high, and
a high on-resistance when the voltage at the output terminal is low.

13. The rectifying circuit according to claim 10, wherein the first rectifying element is a first diode that is connected to the reference potential at an anode thereof and to the first antenna terminal at a cathode thereof, and
the second rectifying element is a second diode that is connected to the reference potential at an anode thereof and to the second antenna terminal at a cathode thereof.

14. A contactless IC card comprising a rectifying circuit,
wherein the rectifying circuit comprises:
a first transistor connected to a reference potential at a first end of a current path thereof and to a first antenna terminal at a second end of the current path thereof;
a second transistor connected to the reference potential at a first end of a current path thereof and to a second antenna terminal at a second end of the current path thereof;
a first rectifying element connected between the first antenna terminal and a rectified current output node, a forward direction of which is a direction from the first antenna terminal to the rectified current output node;
a second rectifying element connected between the second antenna terminal and the rectified current output node, a forward direction of which is a direction from the second antenna terminal to the rectified current output node;
a first switch element connected in parallel with the first transistor between the reference potential and the first antenna terminal; and
a second switch element connected in parallel with the second transistor between the reference potential and the second antenna terminal.

15. The contactless IC card according to claim 14, the first switch element is controlled depending on a second current flowing through the second rectifying element, and
the second switch element is controlled depending on a first current flowing through the first rectifying element.

16. The contactless IC card according to claim 15, wherein the first switch element is turned off and the first transistor is turned on when the second current is lower than a second threshold,
both the first switch element and the first transistor are turned on when the second current is equal to or higher than the second threshold,
the second switch element is turned off and the second transistor is turned on when the first current is lower than a first threshold, and
both the second switch element and the second transistor are turned on when the first current is equal to or higher than the first threshold.

17. The contactless IC card according to claim 16, wherein the rectifying circuit further comprises:
a voltage generating part that generates, from a current flowing to the rectified current output node, a voltage to be supplied to the control ends of the first transistor and the second transistor.

18. The contactless IC card according to claim 17, wherein the voltage generating part comprises:
a first resistor connected to the rectified current output node at a first end thereof; and
a third transistor connected to a second end of the first resistor at a first end of a current path thereof, to the reference potential at a second end of the current path, and to the first end of the current path and the control ends of the first transistor and the second transistor at a control end thereof.

19. The contactless IC card according to claim 16, wherein the first switch element is a fourth transistor that is connected to the reference potential at a first end of a current path thereof and to the first antenna terminal at a second end of the current path,
the second switch element is a fifth transistor that is connected to the reference potential at a first end of a current path thereof and to the second antenna terminal at a second end of the current path, and
the rectifying circuit further comprises:
a voltage applying part that applies a voltage that depends on the second current to a control end of the fourth transistor and applies a voltage that depends on the first current to a control end of the fifth transistor.

20. The contactless IC card according to claim 19, wherein the first rectifying element is a sixth transistor connected to the first antenna terminal at a first end of a current path thereof and to the rectified current output node at a second end of the current path and a control end thereof,
the second rectifying element is a seventh transistor connected to the second antenna terminal at a first end of a current path thereof and to the rectified current output node at a second end of the current path and a control end thereof,
the voltage applying part comprises:
an eighth transistor connected to the first antenna terminal at a first end of a current path thereof and to the control end of the fifth transistor at a second end of the current path thereof and to the control end of the sixth transistor at a control end thereof,
a ninth transistor connected to the second antenna terminal at a first end of a current path thereof and to the control end of the fourth transistor at a second end of the current path thereof and to the control end of the seventh transistor at a control end thereof,
a second resistor connected to the control end of the fifth transistor at a first end thereof and to the reference potential at a second end thereof, and
a third resistor connected to the control end of the fourth transistor at a first end thereof and to the reference potential at a second end thereof.
